(19) United States
(12) Patent Application Publication
(10) Pub. No.: US 2012/0262716 A1
(43) Pub. Date: Oct. 18, 2012

(54) METHOD AND SYSTEM FOR INTELLIGENTLY IDENTIFYING AND READING AN IMMUNOCHROMATOGRAPHIC STRIP AND APPLICATION THEREOF

(75) Inventors: Jihua Wang, Guangzhou (CN); Wenmei Li, Guangzhou (CN)

(73) Assignee: GUANGZHOU WONDFO BIOTECH. CO., LTD., Guangzhou (CN)

(21) Appl. No.: 13/517,393

(22) PCT Filed: Aug. 17, 2010
(86) PCT No.: PCT/CN2010/076072

§ 371 Date: Jun. 20, 2012

(30) Foreign Application Priority Data
Dec. 22, 2009 (CN) 200910214016.1

(51) Int. Cl. G01N 21/55; G01N 21/59

(52) U.S. Cl. 356/432; 356/445

(57) ABSTRACT

A method and system for intelligently identifying and reading an immunochromatographic strip is disclosed. The method includes the following steps: (a) preparing an immunochromatographic strip provided with a bar code, that is, setting a bar code on an immunochromatographic strip to form a bar code layer; (b) identifying the immunochromatographic strip provided with a bar code through a bar code identification circuit, and dispatching an analysis program corresponding to the type of the immunochromatographic strip provided with a bar code; (c) transmitting visible light to irradiate the immunochromatographic strip provided with a bar code through a light-emitting diode (LED) circuit controlled by a central processing unit; receiving reflected or transmitted light through a photoelectrical sensor and converting the received light into electrical signals; and then amplifying the electrical signals through a signal amplification circuit and transmitting the amplified signals to the central processing unit in order to analyze the signals through the analysis program dispatched in step (b); and (d) outputting an analysis result.

### FIELD OF THE INVENTION

The present invention relates to the field of the health care and the family disease self-test in medical testing, and particularly to a method and system for intelligently identifying and reading an immunochromatographic strip and application thereof.

### BACKGROUND OF THE INVENTION

Immunochromatography is a type of rapid detection technology based on immunofiltration in the 20th century, early 90s late 80s. It is characterized in that an antigen (or antibody) which can form an immunocomplex with an antibody (or antigen) in the sample to be tested, is immobilized in advance to a specific zone of an immunochromatographic strip in band shape. The antigen (or antibody) in the sample to be tested forms a steady complex in advance with a pigment marker during a migration process in a developing system, and then the antigen (or antibody) bound with the pigment marker in the sample migrates further to the specific zone (i.e. the position applied with antibody (or antigen)) and is captured by the antigen-antibody interaction, and herein at the specific zone, a colored band may appear because of the pigment marker.

The immunochromatography does not need to separate the bound antigen (or antibody) and free antigen (antibody). Therefore, its operation is easy and fast, and quite suitable for on-site detections. Accordingly, the immunochromatographic strip based on immunochromatography has developed very rapidly, and it is adapted to whatever situation suitable to be detected through immune reactions.

However, at present, the detection result of the immunochromatographic strip is determined mainly by naked eyes. Therefore, the detection result of the immunochromatographic strip is generally only used as a qualitative determination result. Also, when the concentration of an object to be tested is very low, and coloration is very slight, it is difficult to determine the result and thus cause erroneous determination. Moreover, after every test, the original detection result can not be reserved and personal information is not easy to be tracked. Accordingly, devices for detecting the detection result of the immunochromatographic strip are then developed. At present, the reported electronic pens for reading the result of the immunochromatographic strip have the following disadvantages: (1) They can not automatically identify the type of the immunochromatographic strip, for example the American patents with patent number U.S. Pat No. 7,315,378 B2 and U.S. Pat. No. 7,239,394 B2 both provide a device capable of identifying and reading an immunochromatographic strip prepared based on optical principle, but the device is in lack of a function of automatic identifying the type of the immunochromatographic strip. Therefore, the main difference among different types of the immunochromatographic strips lies in the antigen or antibody combined thereof, while the appearances of them are similar. Accordingly, in occasions that need using many different types of immunochromatographic strips, for example an inspection department, and if the immunochromatographic strips were intermingled, it would ruin the obtained detection results, causing serious consequences. (2) The intelligence degree to identify the type of the immunochromatographic strip is low, for example The Chinese patent application No. 200710058401.2 in a title of “an electronic instrument for female physiological state” provides an electronic instrument for detecting female physiological state, which may analyze strips for detecting female ovulatory period and strips for testing female pregnancy. The identifying process on the strips by the electronic instrument is through mechanically identifying system or the small aperture imaging mechanism. This method requires to make an opening or a hole on strips, its intelligence degree is low, and the electronic instrument has no data storage function. Furthermore, according to the immunochromatographic principle, the matrix of the immunochromatographic strip should be materials with pores, for example, the commonly used nitrocellulose membrane, enabling liquids to migrate in the same direction. The pore diameters will be influenced as the pore size changes during the matrix absorbing liquids, thus the pore size in the immunochromatographic strip should not be too small, otherwise it will cause deviation. In addition, because normal specification of the immunochromatographic strip is 3 mm wide and 7 cm long, it is impossible to identify dozens of immunochromatographic strips by making pores. Further, pore manufacturing on the immunochromatographic strips requires high techniques and high preparation cost, and is against the popularization and application.

### SUMMARY OF THE INVENTION

A first object of the present invention is to overcome the disadvantage that the extent of intelligence to identify the type of an immunochromatographic strip is low in prior art, and provide a method of intelligently identifying and reading an immunochromatographic strip.

A further object of the present invention is to provide a system to implement the method mentioned above.

A still further object of the present invention is to provide an application of the system. The objects of the present invention are achieved by the following technical solution:

A method for intelligently identifying and reading an immunochromatographic strip, comprising following steps:
(1) setting a bar code on an strip for immunochromatography to form a bar code layer, and thus to obtain an immunochromatographic strip provided with the bar code;
(2) identifying the immunochromatographic strip provided with the bar code by a bar code identification circuit, and dispatching an analysis program corresponding to the type of the immunochromatographic strip provided with the bar code;
(3) emitting visible light to irradiate the immunochromatographic strip provided with the bar code through a light-emitting diode (LED) circuit controlled by a central processing unit, and receiving reflected or transmitted light through a photoelectric sensor and converting the received light into electrical signals, and then amplifying the electrical signals through a signal amplification circuit and transmitting the amplified signals to the central processing unit in order to analyze the amplified signals through the analysis program dispatched in step (2);
(4) outputting an analysis result.

The method may also include a step of storing the analysis result.

Preferably, the storing is to store in the central processing unit or to store by a data storage circuit.

Preferably, the bar code layer and a sample loading end of the strip for immunochromatography are located at both ends of the strip for immunochromatography respectively.

The strip for immunochromatography is preferably encapsulated by fastener and is fixed to obtain the immunochromatographic strip provided with the bar code. The sample loading end of the strip for immunochromatography is not encapsulated by a fastener. An observation window is set on the fastener, and the strip for immunochromatography in the observation window is exposed to allow lights to directly irradiate the strip for reading.

Preferably, the bar code layer is located on the strip for immunochromatography. The observation window includes a part of the strip applied with the antibody (or antigen) for immunochromatography and the bar code layer.

Preferably, the bar code layer is located on the fastener, and preferably the observation window only includes a part of the strip for immunochromatography which is applied with the antibody (or antigen).

Preferably, the bar code layer is a one-dimensional bar code layer or two-dimensional bar code layer.

The setting is preferably in a form of printing the bar code or pasting a paster printed with the bar code.

A particular identifying process of the step (2) is that the immunochromatographic strip provided with the bar code is inserted into a strip test connector, and a power switch of a bar code identification circuit is closed by a bar code interface circuit, and light emitted by a light source in the bar code identification circuit will irradiate the bar code of the immunochromatographic strip provided with the bar code through a lens, and the reflected light is converted to electrical signal by a photoelectric converter, and then the electrical signal is transmitted to the central processing unit by an amplification and shaping circuit.

The photoelectric sensor of step (3) is preferable a photosensitive diode.

The outputting of step (4) is preferable in a form of outputting to a display device.

The monitor is preferable a LCD display screen.

A system for implementing the method for intelligently identifying and reading an immunochromatographic strip, which consists of a detection and analysis device and an immunochromatographic strip provided with a bar code, and the immunochromatographic strip provided with the bar code can be movably inserted into a strip test connector of the detection and analysis device.

Preferably, the immunochromatographic strip provided with the bar code includes a strip for immunochromatography and a bar code layer. The strip for immunochromatography includes a sample-loading end and a part applied with the antibody (or antigen).

Preferably, the bar code layer and the sample loading end are located at both ends of the strips for immunochromatography respectively.

Preferably, the immunochromatographic strip provided with the bar code further includes a fastener for encapsulating the strip for immunochromatography, and the sample loading end is exposed, and a function of the fastener is to fix the strip for immunochromatography. An observation window is provided on the fastener, which makes the strip for immunochromatography exposed in the observation window, allowing lights to directly irradiate the strip for reading.

Preferably, the bar code layer is located on the strip for immunochromatography, and the observation window includes a part of the strip for immunochromatography applied with the antibody (or antigen), and the bar code layer.

Preferably, the bar code layer is located on the fastener, and preferably the observation window only includes the part of the strip for immunochromatography which is applied with the antibody (or antigen).

Preferably, the bar code layer is a one-dimensional bar code layer or two-dimensional bar code layer.

The setting is preferably in a form of setting the bar code or pasting paster printed with a bar code.

Preferably, the detection and analysis device consists of a housing and a measuring and controlling circuit installed within the housing; a LCD display screen and a strip test connector are provided on a surface of the housing; the measuring and controlling circuit includes a power supply circuit, a photoelectric sensor, a signal amplification circuit, a LED circuit and a central processing unit; the power supply circuit, the LCD display screen and the LED circuit are connected with the central processing unit respectively, and the photoelectric sensor, the signal amplification circuit and the central processing unit are connected successively; the measuring and controlling circuit also includes a bar code identification circuit connected with the central processing unit.

Preferably, the bar code identification circuit preferably includes a switch, a light source, a lens, a photoelectric converter, an amplification and shaping circuit and a bar code interface circuit; the light source, the switch and the bar code interface circuit are connected successively, and the bar code interface circuit is controlled by the central processing unit; the lens and the photoelectric converter are disposed on the same side of the light source; the photoelectric converter is connected with the amplification and shaping circuit which is connected with the central processing unit by the bar code interface circuit.

Preferably, the detection and analysis device also includes a data storage circuit connected with the central processing unit, to facilitate the storing of the analysis result.

Or, the central processing unit is preferable a central processing unit with a function of data storage, to achieve the storing of the analysis result.

The photoelectric sensor is preferable a photosensitive diode.

The power supply circuit is preferable a removable battery, in favor of sorting operation after use and environmental protection.

The battery is preferable a lithium cell battery.

The measuring and controlling circuit also includes a voice circuit connected with the central processing unit, in favor of reminding a user to browse a result at a proper time.

Further, a key connected with the central processing unit is preferably provided on the surface of the housing; the key may be used to select an analysis program of test items to dispatch a proper program when the immunochromatographic strip can not be identified by the identification circuit; the key may be further used to store data and dispatch stored data.

The key is preferable a three-dimensional key.

The device for intelligently identifying and reading immunochromatographic strips is applied in the field of medical tests.

The device is adapted to test items including FOB, HCG HBsAg, HBsAb, BeAb, HbcAb, HbeAg, LH, PSA, HIV, etc.

The principle of the present invention is that a result can be read and identified correctly only when the different test items were applied with particular different processing methods, as illustrated in the following three cases. Different test immunochromatographic strips are identified by the bar code identification circuit in the present invention, and in a particular test, a corresponding analysis program is dispatched to implement different item tests:
(1) test items using the principles of double antibody sandwich ELISA and indirect ELISA mechanisms: when a T line (detection line) and a C line (control line) are both chromogenic, the result is positive, and when the T line is not chromogenic and the C line is chromogenic, the result is negative, for example FOB, HCG, HBsAg, HBsAb, HbeAg, HIV, etc.;
(2) test items using the principles of the competitive or inhibition reactions: on contrary to using the principles of the double antibody sandwich ELISA and indirect ELISA mechanisms, when the T line is not chromogenic and the C line is chromogenic, the result is positive, and when the T line and C line are chromogenic at the same time, the result is negative, for example HBeAb, HBcAb, etc.;
(3) when color development of T line is competitive or deeper than that of the C line, the result is positive, and when color development of the T line is lighter than that of the C line, the result is negative, for example LH, PSA, etc.

The present invention has the following advantages and effects compared with prior arts:
1. The method for intelligently identifying and reading an immunochromatographic strip according to the present invention is developed with high degree of intelligence. Different types of the immunochromatographic strips are identified by the method for identifying the bar code in the present invention, and a result of the immunochromatographic strip is analyzed and outputted by a corresponding analysis program dispatched. It is in favor of correctly determining the result of different immunochromatographic strips, and ensuring the accuracy of the test result. It is not only in favor of application for people without professional background, but also be in favor of application in occasions with a lot of testing work.
2. The method for intelligently identifying and reading an immunochromatographic strip according to the present invention processes the photoelectric signal by the central processing unit, and the result is objective and accurate, avoiding mistakes caused by subjective observation.
3. In the system to realize the method for intelligently identifying and reading an immunochromatographic strip according to the present invention, it is easier to apply a bar code layer on the immunochromatographic strip, and another detection and analysis device may analyze the immunochromatographic strip provided with the bar code of a different test item, i.e., the immunochromatographic strip provided with a bar code may be changed, at very low cost.
4. The operation of the detection and analysis device is easy, and it only needs to insert the immunochromatographic strip provided with a bar code into the strip test into the connector of the detection and analysis device, turn on the switch, and then make the immunochromatographic strip provided with the bar code contact a sample, not requiring any professional training.
5. In addition, the use of the removable battery in the detection and analysis device according to the present invention is in favor of environment protection; the arrangement to make it have the function of data storage is in favor of tracking tester's situation.

### BRIEF DESCRIPTION OF THE DRAWINGS

FIG. 1 schematically illustrates a structure of a system according to embodiment 1.

FIG. 2 schematically illustrates a structure of an immunochromatographic strip provided with a bar code according to embodiment 1.

FIG. 3 is a block plan of the work principle of a detection and analysis device according to embodiment 1.

FIG. 4 is a block plan of the work principle of a bar code identification circuit according to the present invention.

FIG. 5 is a block plan of the work principle of a detection and analysis device according to embodiment 2.

FIG. 6 is a block plan of the work principle of a detection and analysis device according to embodiment 3.

FIG. 7 schematically illustrates a structure of an immunochromatographic strip provided with a bar code according to embodiment 4.

FIG. 8 schematically illustrates a structure of a system according to embodiment 6.

FIG. 9 is a block plan of the work principle of a detection and analysis device according to embodiment 6.

FIG. 10 is a block plan of the work principle of a detection and analysis device according to embodiment 7.

### DETAILED DESCRIPTION OF THE PREFERRED EMBODIMENTS

The present invention will be explained further in details with reference embodiments and drawings in below, but the implementation mode of the present invention is not limited to the following explanation.

### Embodiment 1

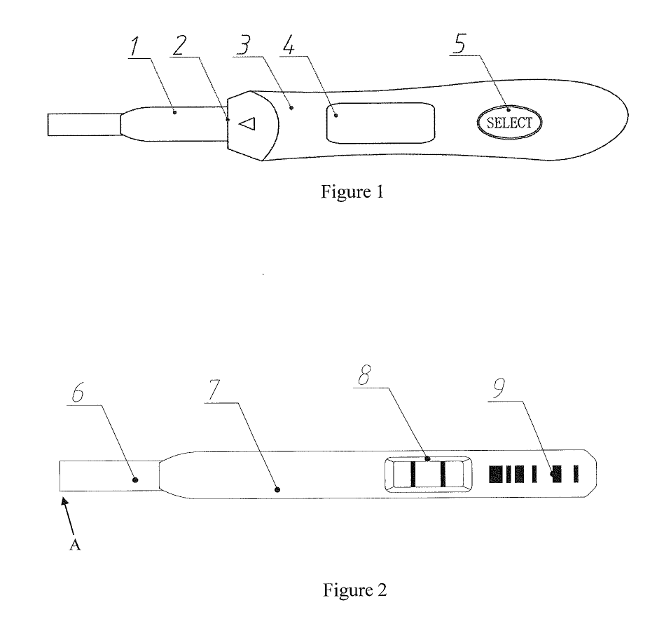

A system to implement a method for intelligently identifying and reading an immunochromatographic strip according to this embodiment is illustrated in FIG. 1, and an immunochromatographic strip 1 provided with a bar code is inserted into a strip test connector 2. A structure of the immunochromatographic strip 1 provided with a bar code is schematically illustrated in FIG. 2.

As illustrated in FIG. 1, a detection and analysis device consists of a housing 3 and a measuring and controlling circuit installed within the housing. A strip test connector 2, a LCD display screen 4 and a key 5 (a 3D key) are provided on the surface of the housing.

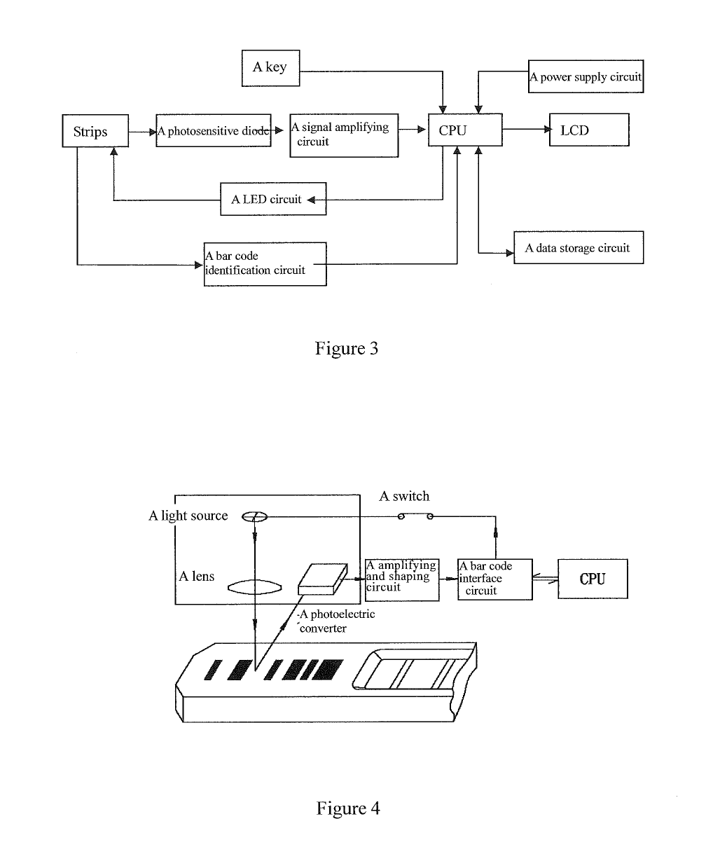

As illustrated in FIG. 3, the measuring and controlling circuit includes a power supply circuit, a bar code identification circuit, a photosensitive diode, a signal amplification circuit, a LED circuit, a data storage circuit and a central processing unit; wherein, the power supply circuit, the bar code identification circuit, the LCD display screen, the data storage circuit and the LED circuit are connected with the central processing unit respectively, and the photosensitive diode, the signal amplification circuit and the central processing unit are connected successively. Through the bar code in the strip that is identified by the bar code identification circuit, the test items are determined, or the key also may be used to select a particular test item, and the corresponding program is automatically dispatched by the system, and the final result will show directly on the LCD screen.

Wherein, the bar code identification circuit is illustrated in FIG. 4, a light source, a switch and a bar code interface circuit are connected successively, and the bar code interface circuit is controlled by the central processing unit; a lens and a photoelectric converter are disposed on the same side of the light source; the photoelectric converter is connected with an amplification and shaping circuit which is connected with the central processing unit. When the immunochromatographic strip provided with a bar code is inserted into the strip test connector 2 of the device illustrated in FIG. 1, the switch of the bar code identification circuit will be closed by the bar code interface circuit, and the light emitted by the light source in the bar code identification circuit irradiates the bar code of the immunochromatographic strip provided with a bar code through the lens, and the reflected light is converted to an electrical signal by the photoelectric converter, and then the electrical signal is transmitted to the central processing unit (CPU) by the amplification and shaping circuit. According to the electrical signal from the bar code identification circuit, the CPU dispatches an analysis program corresponding to the type of the immunochromatographic strip provided with a bar code, and starts the determination on a result of the strip.

As illustrated in FIG. 2, the immunochromatographic strip provided with a bar code 1 consists of a strip for immunochromatography 6 and a fastener 7 for encapsulating the strip for immunochromatography. The strip for immunochromatography 6 includes an exposed sample loading end A (not encapsulated in the fastener), and the fastener 7 have openings for an observation window 8 and a bar code layer 9, the test region of the observation window 8 for the strip for immunochromatography 6 applied with antibody (or antigen) is exposed, and the bar code layer 9 is located on the other end of the strip for immunochromatography 6; opposite to the sample loading end A. When the immunochromatographic strip 1 provided with a bar code layer is inserted into the strip test connector 2, the observation window 8 and the bar code layer 9 are located in the device illustrated in FIG. 1.

During a test, an immunochromatographic strip 1 provided with a bar code is inserted into the strip test connector 2, the bar code layer on the immunochromatographic strip 1 provided with a bar code will be identified by the bar code identification circuit, and then an electrical signal is transmitted to the central processing unit. Then, a corresponding analysis program is dispatched by the central processing unit, the sample loading end of the immunochromatographic strip 1 provided with the bar code is contacted with a sample. the LED circuit controlled by the central processing unit emits visible light to irradiate the strip applied with antibody (or antigen) included by the observation window 8, and the reflected light is absorbed by the photosensitive diode and converted into an electrical signal, then the electrical signal is amplified by the amplification circuit and transmitted to the central processing unit and then analyzed by the analysis program correspondingly dispatched, and the analysis result will be outputted and shown on the LCD display screen 4. The analysis result is stored by the data storage circuit through the key 5, and the stored analysis result can be dispatched by the key 5 as well.

The present invention utilizes the light reflection principle as follows:

White light is composed of various colors of light. The color of an object seen by people is because the object reflects light. Different objects have different light reflection abilities. Accordingly, people can identify different colors. For example, a white object reflects all light, and the color identified by human eyes is white; a red object mainly reflects red light and absorbs other colors light, and the color identified by human eyes is red; a black object absorbs all light and almost dose not reflect light, and accordingly the color identified by human eyes is black. The principle of the present invention is similar to the color identification principle by human eyes. The present invention utilizes a light-emitting diode to emit light, and the light-emitting diode can also receive the light reflected back. When light irradiates the colored band, if the band is not chromogenic, the light is nearly all reflected due to the background of most rapid diagnosis reagents are white, and if the band is chromogenic, only the light corresponding to the colored band is reflected, other colors are absorbed by the band, thus it is easy to determine the existence of the band, and show the test result to a tester. The reflected light received by the photoelectric diode of the system is all from a special light-emitting diode, without contamination by adjacent light-emitting diode or other light. The photoelectric diode as a normal diode is a type of semiconductor element having one PN junction. However, the photoelectric diode has a specific function, i.e. when the photoelectric diode works under a reverse bias voltage station or unbiased voltage station; it produces a reverse electric current. The reverse electric current strength is proportional to incident light power. The larger the power of the incident light is, the bigger the reverse electric current is, while in contrast, the smaller the power of the incident light is, the smaller the reverse electric current is. The photoelectric diode can convert a light signal into an electrical signal by utilizing the characteristic that any change of light will cause a change of electrical current of the photoelectric diode. In a practical circuit application, utilizing the reverse bias voltage and load resistance may convert an electrical signal converted from light energy by the photoelectric diode into a voltage signal, and then the analog voltage signal is converted into a digital signal by an analog-to-digital converting circuit, in favor of computation of the central processing unit. However, small electrical current signal converted from the light energy by the photoelectric diode has low resolution capability. Accordingly, herein the signal amplification circuit is needed to amplify the signal at proper multiples, and there is a good resolution capability and also the signal is not reaching a saturation state. The central processing unit calculates the conventionally obtained digital signal and determines the test result.

### Embodiment 2

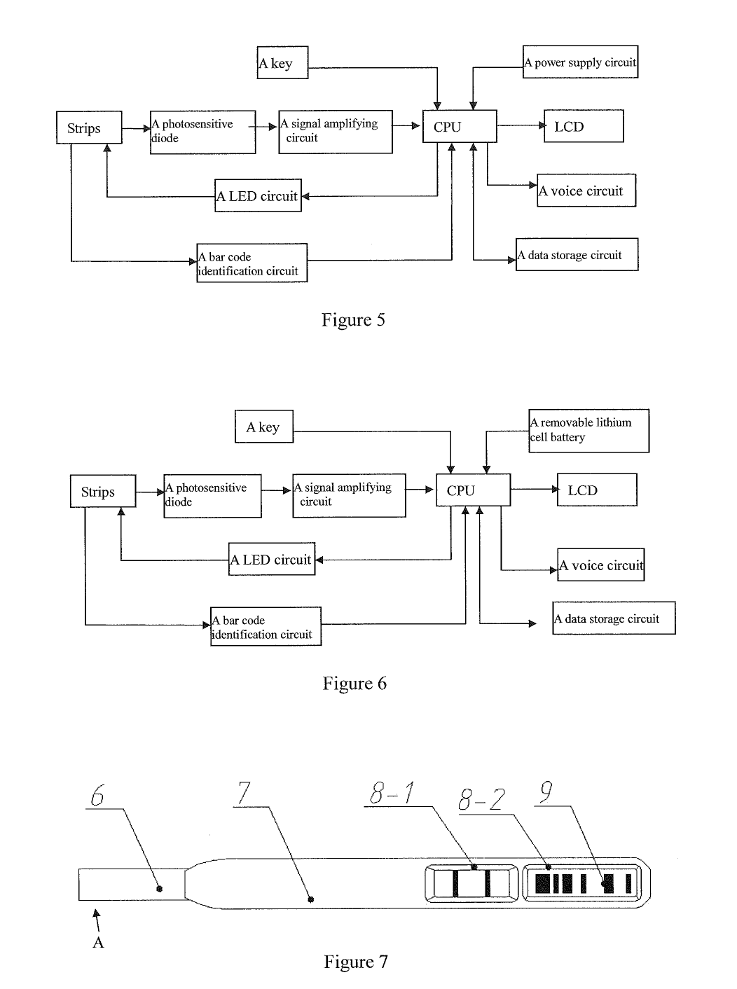

The system to implement a method for intelligently identifying and reading an immunochromatographic strip according to this embodiment is different from that of embodiment 1 only in that the measuring and controlling circuit of the detection and analysis device further includes a voice circuit connected with the central processing unit, as illustrated in FIG. 5.

### Embodiment 3

The system to implement a method for intelligently identifying and reading an immunochromatographic strip according to this embodiment is different from that of embodiment 2 only in that the power supply circuit in the measuring and controlling circuit of the detection and analysis device is a removable lithium cell battery, as illustrated in FIG. 6.

### Embodiment 4

The system to implement a method for intelligently identifying and reading an immunochromatographic strip according to this embodiment is different from that of embodiment 1 only in that the bar code layer 9 of the immunochromatographic strip provided with a bar code is printed on the strip for immunochromatography 6, and there are two observation windows (respectively, 8-1 and 8-2) on the fastener 7, and the observation window 8-1 includes an exposed part of the strip for immunochromatography which is applied with the antibody (or antigen), and the observation window 8-2 includes the exposed bar code layer 9, illustrated as FIG. 7.

### Embodiment 5

The system to implement a method for intelligently identifying and reading an immunochromatographic strip according to this embodiment is different from that of embodiment 3 only in that the immunochromatographic strip provided with a bar code is the same as that of embodiment 4.

### Embodiment 6

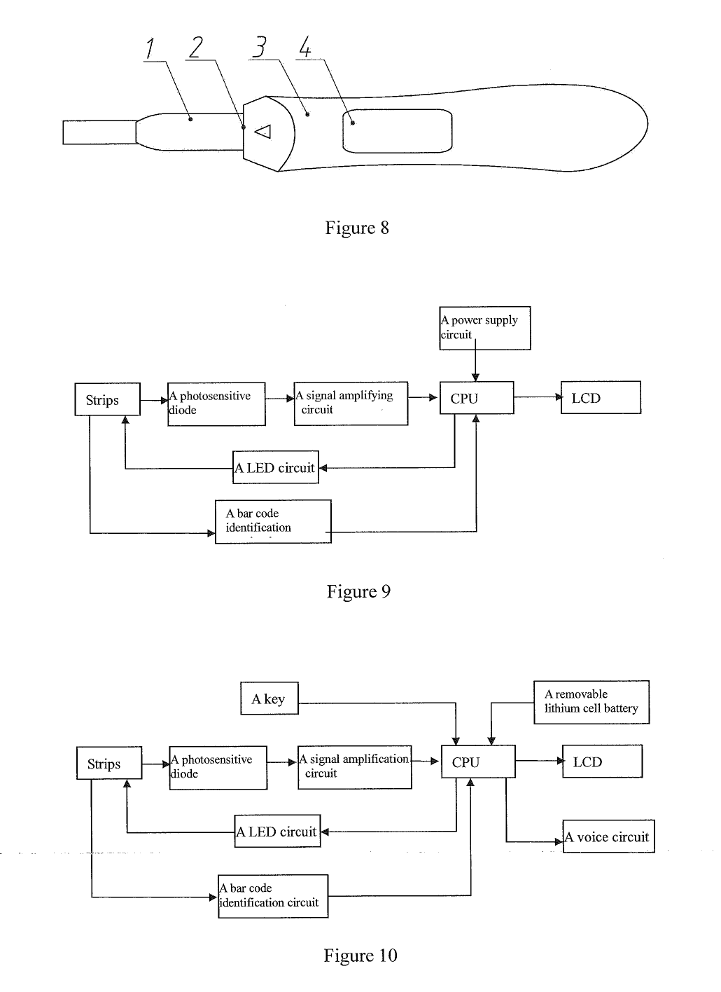

The system to implement a method for intelligently identifying and reading an immunochromatographic strip according to this embodiment is different from that of embodiment 1 only in that the detection and analysis device does not include a key on the housing (as illustrated in FIG. 8), and the measuring and controlling circuit does not include the data storage circuit. The work principle is illustrated in FIG. 9.

### Embodiment 7

A system to implement a method for intelligently identifying and reading an immunochromatographic strip according to this embodiment is different from that of embodiment 2 only in the utilizing of the central processing unit with function of data storage, and that the measuring and controlling circuit dose not includes the data storage circuit. The work principle is illustrated in FIG. 10.

The above embodiments are preferred application modes of the present invention, but application modes of the present invention are not limited thereof, and any other changes, modification, substitution, combination, simplification within the spirit and principle of the present invention should be regarded as an equivalent displacement of the present invention, and are included within the protection scope of the present invention.

1. A method for intelligently identifying and reading an immunochromatographic strip, comprising the following steps:
(1) setting a bar code on a strip for immunochromatography to form a bar code layer, and thus to obtain the immunochromatographic strip provided with the bar code;
(2) identifying the immunochromatographic strip provided with the bar code by a bar code identification circuit, and dispatching an analysis program corresponding to the type of the immunochromatographic strip provided with the bar code;
(3) transmitting visible light to irradiate the immunochromatographic strip provided with the bar code through a light-emitting diode circuit controlled by a central processing unit, and receiving the reflected or transmitted light through a photoelectric sensor and converting the received light into electrical signals, and then amplifying the electrical signals through a signal amplification circuit and transmitting the amplified signals to the central processing unit in order to analyze the amplified signals through the analysis program dispatched in step (2);
(4) outputting an analysis result.

2. The method according to claim 1, wherein a particular process of the identifying of step (2) is that the immunochromatographic strip provided with the bar code is inserted into a strip test connector, and a power switch of the bar code identification circuit is closed by a bar code interface circuit, and light emitted by a light source in the bar code identification circuit will irradiate the bar code of the immunochromatographic strip provided with the bar code through a lens, and the reflected light is converted to an electrical signal by a photoelectric converter, and then the electrical signal is transmitted to the central processing unit by a amplification and shaping circuit.

3. The method according to claim 1, wherein the method comprises a step of storing the analysis result.

4. A system for implementing the method for intelligently identifying and reading an immunochromatographic strip according to claim 1, wherein the system consists of the immunochromatographic strip provided with the bar code and a detection and analysis device, and the immunochromatographic strip provided with the bar code can be movably inserted into a strip test connector of the detection and analysis device;
the detection and analysis device consists of a housing and a measuring and controlling circuit installed within the housing; a LCD display screen and a strip test connector are provided on a surface of the housing; the measuring and controlling circuit comprises a power supply circuit, a photoelectric sensor, a signal amplification circuit, a LED circuit and a central processing unit;
the power supply circuit, the LCD display screen and the LED circuit are connected with the central processing unit respectively, and the photoelectric sensor, the signal amplification circuit and the central processing unit are connected successively; wherein, the measuring and controlling circuit further comprises a bar code identification circuit connecting with the central processing unit.

5. The system according to claim 4, wherein the measuring and controlling circuit further comprises a data storage circuit connected with the central processing unit.

6. The system according to claim 4, wherein the central processing unit is a central processing unit with a function of storing data.

7. The system according to claim 4, wherein the bar code identification circuit comprises a switch, a light source, a lens, a photoelectric converter, an amplification and shaping circuit and a bar code interface circuit;
the light source, the switch and the bar code interface circuit are connected successively, and the bar code interface circuit is controlled by the central processing unit; the lens and the photoelectric converter are disposed on a same side of the light source; the photoelectric converter is connected with the amplification and shaping circuit which is connected with the central processing unit by the bar code interface circuit.

8. The system according to claim 4, wherein the power supply circuit is a removable battery.

9. The system according to claim 6, wherein the measuring and controlling circuit further comprises a voice circuit connecting with the central processing unit.

10. An application of the system according to claim 9 in the field of medical tests.
